(19) United States
(12) Patent Application Publication
(10) Pub. No.: US 2005/0169472 A1
(43) Pub. Date: Aug. 4, 2005

(54) Prepaid card type data recording medium, recording apparatus thereof, apparatus for providing contents, and method used for authenticating the data recording medium

(75) Inventors: Sung-hyu Han, Seoul (KR); Yun-sang Kim, Suwon-si (KR); Yang-lim Choi, Gyeonggi-do (KR); Yong-kuk You, Seoul (KR); Hee-chul Han, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/002,249

(22) Filed: Dec. 3, 2004

(30) Foreign Application Priority Data
Dec. 3, 2003 (KR) 2003-87248

(51) Int. Cl. H04N 7/167

(52) U.S. Cl. 380/227

(57) ABSTRACT

A data recording medium, a recording apparatus thereof, and an apparatus for providing contents having a function of securing personal anonymity similar to a prepaid card. The prepaid card type data recording medium includes a control information area on which is recorded coupon ID information for identifying the data recording medium and representing the authority for recording contents. In addition, marginal capacity information for indicating the maximum downloadable capacity of contents may further be recorded on the control information area. The apparatus for providing contents includes an authentication unit for authenticating personal identification information, and a contents upload unit for uploading predetermined contents to the data recording medium when the authentication is successful in the authentication unit. In addition, the apparatus for providing contents further includes an information DB unit which stores marginal capacity information indicating the marginal capacity of contents to be downloaded to the data recording medium according to the coupon ID information. The authentication unit determines whether to upload the predetermined contents by referring to the information DB. Blueray disc, the next generation DVD, can be used in a mobile phone or PDA as a prepaid card type data recording medium.

### BACKGROUND OF THE INVENTION

This application claims the priority of Korean Patent Application No. 2003-87248, filed on Dec. 3, 2003, in the Korean Intellectual Property Office, the disclosure of which is incorporated herein in its entirety by reference.

1. Field of the Invention

The present invention relates to a data recording medium, such as a prepaid card type data recording medium, an apparatus for providing contents to the prepaid card type data recording medium, and an encryption authentication method used for such a data recording medium.

2. Description of the Related Art

A digital versatile disc (DVD) is an optical storage medium used to record audio/video data or computer software. The DVD is similar to an existing compact disc (CD) in its structure and application technique, but is far superior to the CD in its data storage capacity.

Meanwhile, an interactive DVD operates with a platform-independent navigation engine to play an interactive image. While viewing a DVD, a user selects a specific item on a DVD screen to search additional information from the selected web site or download the information to a storage medium such as a hard disc. A DVD-Video disc is an example of the interactive DVD.

Contents such as music and video are pre-recorded on the interactive DVD, and additional information related to the contents can be provided to users through web sites using the interactive DVD. However, the conventional interactive DVD has not previously provided a function of downloading contents to a user. Rather, the user must connect to a server for providing contents and settle accounts using his or her personal credit information in order to download charged contents. Therefore, there has been a problem in that its usage is inconvenient and personal anonymity may not be secured.

A so-called prepaid card has been commonly used to pay transportation fare or public telephone charge. However, since such a prepaid card has a limited recording capacity, it is impossible to record contents such as music or video on the prepaid card. In addition, there is an IC type prepaid card. The IC type prepaid card is, however, too expensive to be used only with the function of a prepaid card.

### SUMMARY OF THE INVENTION

According to one exemplary embodiment, the present invention provides a data recording medium capable of securing personal anonymity when downloading contents, by using a DVD in a manner similar to a prepaid card but overcoming the high-cost problem of the prepaid card.

In addition, according to another exemplary embodiment, the present invention provides an apparatus for providing various contents to a prepaid card type data recording medium capable of creating a new profitable business model.

According to an example of the present invention, there is provided a data recording medium comprising: a data area on which contents are to be recorded and a control information area on which is recorded coupon ID information for identifying the data recording medium and representing the authority for recording contents.

The coupon ID information may be encrypted with a predetermined media key.

Marginal capacity information for indicating a maximum downloadable capacity of contents and/or grade information for indicating a grade of the data recording medium may further be recorded on the control information area. In addition, downloadable address information on a communication network may further be recorded on the control information area.

According to another example of the present invention, there is provided a data recording apparatus for recording data on a data recording medium comprising: an area creating unit which creates a data area on which contents are to be recorded, and a control information area on which is recorded control information; and a control information recording unit which records, on the control information area, coupon ID information for identifying the data recording medium and representing the authority for recording contents.

The control information recording unit may encrypt the coupon ID information with a predetermined media key. The control information recording unit may further record on the control information area marginal capacity information for indicating a maximum downloadable capacity of contents and/or grade information for indicating a grade of the data recording medium. In addition, the control information recording unit may further record on the control information area downloadable address information on a communication network.

According to still another example of the present invention, there is provided an apparatus for providing contents to a data recording medium including a data area on which contents are to be recorded and a control information area on which control information including coupon ID information for identifying the data recording medium and representing the authority for contents is recorded, the apparatus comprising: an authentication unit for authenticating the coupon ID information; and a contents upload unit for uploading predetermined contents to the data recording medium when the authentication is successful in the authentication unit.

The apparatus for providing contents may further comprise an information DB unit which stores marginal capacity information indicating the marginal capacity of contents to be downloaded to the data recording medium according to the coupon ID information, and the authentication unit may determine whether to upload the predetermined contents by referring to the information DB. In addition, the information DB unit may further store grade information indicating a grade of the data recording medium according to the coupon ID information, and the authentication unit may further authenticate the grade information to determine whether to upload.

The marginal capacity information indicating the marginal capacity of contents to be downloaded to the data recording medium may further be recorded on the control information area, and the authentication unit may determine whether to upload the predetermined contents by referring to the marginal capacity information. In addition, the grade information indicating the grade of the data recording medium may further be recorded on the control information area, and the authentication unit may further authenticate the grade information to determine whether to upload.

According to still another example of the present invention, there is provided an authentication method performed in a disc driving apparatus between a data recording medium and the disc driving apparatus and between the disc driving apparatus and an apparatus for providing AV contents, the data recording medium including a data area on which AV contents are recorded and a control information area on which coupon ID information for identifying the data recording medium and representing the authority of AV contents is recorded, the disc driving apparatus for driving the data recording medium, and the apparatus for providing the AV contents to the data recording medium, the method comprising: (a) reading the coupon ID information encrypted with a predetermined media key from the data recording medium; (b) decrypting the coupon ID information by using a media key of the disc driving apparatus; (c) creating a predetermined session key; (d) encrypting the decrypted coupon ID information and the session key by using a predetermined public key; and (e) transmitting the information encrypted in (d) to the apparatus for providing AV contents. In addition, the authentication method performed in the disc driving apparatus may further comprise: (f) receiving AV contents encrypted with the session key from the apparatus for providing AV contents; and (g) decrypting the encrypted AV contents with the session key.

According to still another example of the present invention, there is provided an authentication method performed in an apparatus for providing AV contents between a data recording medium and a disc driving apparatus and between the disc driving apparatus and the apparatus for providing AV contents, the data recording medium including a data area on which AV contents are recorded and a control information area on which coupon ID information for identifying the data recording medium and representing the authority of AV contents is recorded, the disc driving apparatus for driving the data recording medium, and the apparatus for providing the AV contents to the data recording medium, the method comprising: (a) receiving the information that the coupon ID information and the session key created in the disc driving apparatus are encrypted by a predetermined public key from the disc driving apparatus; (b) decrypting the information encrypted by the public key with a private key of the apparatus for providing AV contents; (c) identifying the decrypted information as the coupon ID information and the session key created in the disc driving apparatus; (d) comparing the coupon ID information with a predetermined coupon ID information stored in the apparatus for providing AV contents; and (e) encrypting predetermined AV contents by using the session key and transmitting the encrypted AV contents to the disc driving apparatus on the basis of the comparison result.

### BRIEF DESCRIPTION OF THE DRAWINGS

The above and other features and advantages of the present invention will become more apparent by describing in detail exemplary embodiments thereof with reference to the attached drawings in which:

FIG. 1A is a plan view showing a data recording medium according to an embodiment of the present invention;

FIG. 1B is a chart showing control information to be recorded according to an embodiment of the invention.

FIG. 2 is a block diagram showing a data recording medium fabricating system for fabricating a data recording medium according to an embodiment of the present invention;

FIG. 3 is a diagram showing an internal structure of the data recording apparatus of FIG. 2;

FIG. 4 is a conceptual view for explaining a process for playing a data recording medium according to an embodiment of the present invention on a general purpose computer and downloading contents from a content server;

FIG. 5 is a block diagram showing an apparatus for providing contents according to another embodiment of the present invention;

FIG. 6 is a flowchart showing a process that the apparatus for providing contents of FIG. 5 authenticates a data recording medium and uploads contents;

FIGS. 7A-7B are flowcharts showing a method of authenticating a data recording medium performed in a PC of disc driving apparatus according to an embodiment of the present invention; and

FIG. 8 is a flowchart showing a method of authenticating a data recording medium performed in an apparatus for providing contents according to an embodiment of the present invention.

### DETAILED DESCRIPTION OF THE PREFERRED EMBODIMENTS

Exemplary embodiments will now be described in detail with reference to the accompanying drawings.

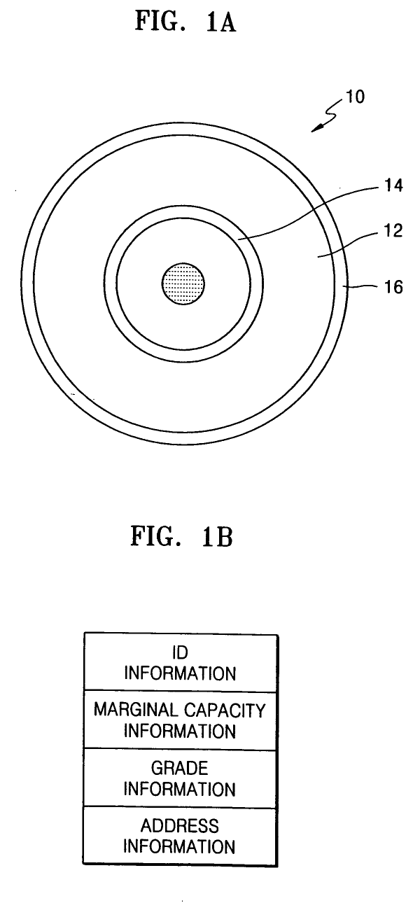

FIG. 1A shows a DVD structure as a data writing medium according to an exemplary embodiment of the present invention. A data recording area of DVD 10 is of the shape of a circular track. Reproducible data such as voice and video contents is recorded on a data area 12. Control information on a disc producer, copyright, copy protection, etc., together with physical information on the last sector number of the data area 12, etc., is recorded on a lead-in area 14. Personal identification information (ID information) of the data recording medium is also recorded on the lead-in area 14. A lead-out area 16 is usually filled with 0.

The ID information is used to distinguish one DVD from another. The ID information may consist of characters and numerals. In addition, the ID information may include a signature of a DVD driver production company or DVD licensing group. In addition, in order to prevent the DVD driver from being illegally copied, the personal identification information may be encrypted using a predetermined media key Km so that the illegally-copied driver cannot play the next-released version of DVD. Therefore, the ID information is used as coupon ID information not only for identifying the data recording medium but also for representing the authority for recording contents depending on the purchase price of the data recording medium.

Meanwhile, the control information includes the marginal capacity information of contents (e.g., maximum downloadable capacity of the recording medium) in addition to the ID information, since the marginal capacity of contents should be indicated depending on the purchase price in order for DVD to have a function of a prepaid card.

In addition, the control information may include web site address information of a content server for providing contents to the data recording medium, DVD price, and DVD grade information depending on purchase age. Therefore, when the DVD is played and web site address information is displayed on the screen, a user can select the address information to conveniently download the contents on the web site. In addition, downloadable contents from the content server may be limited according to purchase age.

FIG. 1B illustrates a structure of the control information to be recorded on the lead-in area 14 of DVD according to an embodiment of the present invention. The control information may include ID information, marginal capacity information, grade information, and address information.

Preferably, the DVD may have a structure of not being erased or rewritten. For instance, a DVD-R may be used as the data recording medium. While the present embodiment has been described only in terms of a DVD as a data recording medium, other examples of the data recording medium for use in the present invention include other recording media such as an optical disc and a mini disc similar to a DVD, or semiconductor memory. In particular, a Blueray disc may also be included which has capacity of over five times the conventional DVD.

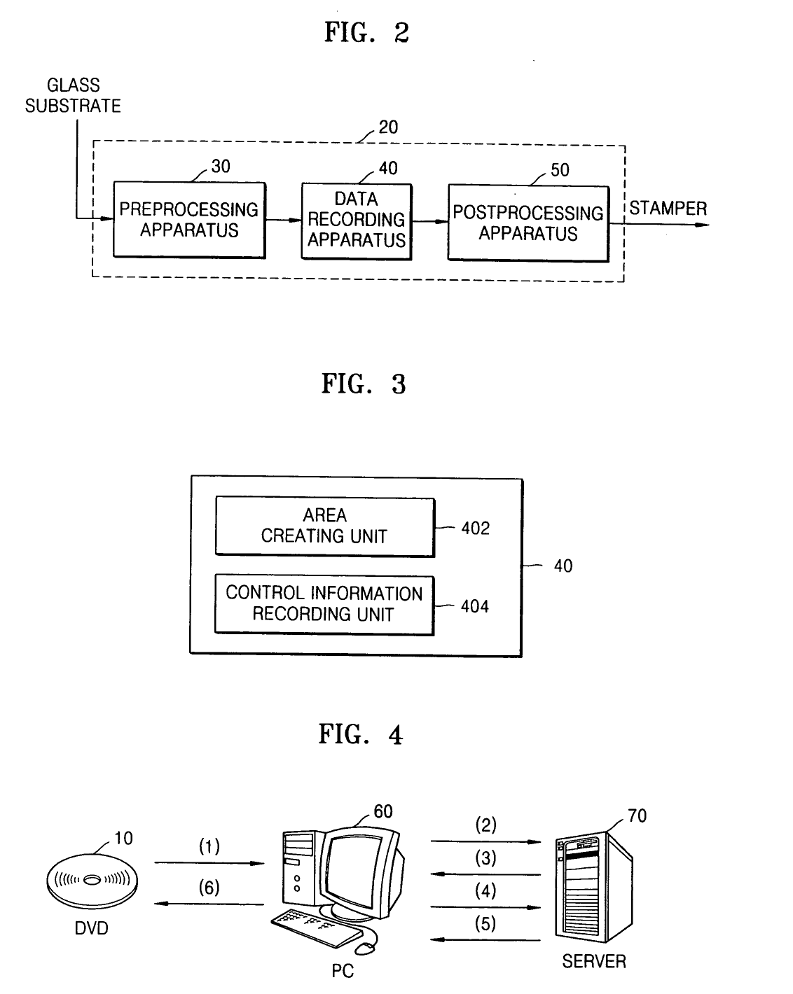

FIG. 2 is a block diagram showing a data recording medium fabricating system 20 for fabricating a prepaid card type DVD of FIG. 1A. In a pretreatment or preprocessing apparatus 30, a DVD glass substrate is subjected to an ultrasonic cleaning process and a photoresist coating process. In a data recording apparatus 40, personal identification information for identifying the DVD, together with various control information, is recorded on the control information area of DVD by using, for example, a laser beam. If necessary, control information such as marginal capacity information, address information of a content server, and grade information may be recorded by apparatus 40. Nothing is recorded on a data area of the prepaid card type DVD.

After recording on the control information area by the data recording apparatus 40, in an aftertreatment or postprocessing apparatus 50, a master disc is produced through a development process. Then, a Ni thin film is deposited on the master disc by sputtering or electroless plating. The coated photoresist is removed by peeling the Ni metal film off the master disc. Next, a backside of the master disc is polished. Therefore, a stamper as a final product is obtained.

The pretreatment apparatus 30 and the aftertreatment apparatus 50 are parts of a typical DVD fabricating system. In a fabricating process of a recording medium other than a DVD, corresponding pretreatment and aftertreatment processes should be performed.

FIG. 3 illustrates the internal structure of the data recording apparatus 40 of FIG. 2. The data recording apparatus 40 comprises an area creating unit 402 and a control information recording unit 404. The area creating unit 402 creates a data area within a storage medium for recording contents and a control information area for recording both various control information and personal identification information which identifies a data recording medium. The control information recording unit 404 records the control information and the personal identification information on the control information area created by the area creating unit 402. If necessary, the control information recording unit 404 also records control information such as marginal capacity information, address information of a content server, and grade information.

FIG. 4 is a conceptual view for explaining a process that a consumer plays back a prepaid card type DVD on his or her own PC and downloads contents from a content server.

In Step 1, a consumer who purchases the prepaid card type DVD 10 plays back the DVD 10 on a general purpose computer 60 such as a PC. The general purpose computer 60 includes, for example, a personal PC but also may be any computer for playing a prepaid card type DVD and downloading any contents. In addition, the general purpose computer 60 may also include a mobile device such as a mobile phone or personal digital assistant (PDA) when a subminiature Blueray disc of about 3 cm in diameter is commercialized and used as a prepaid card type recording medium in a mobile phone or PDA. When the address of a content server is included in the control information recorded on the lead-in area of the DVD 10, a consumer can easily connect to the content server 70 by selecting the address information displayed on the screen. In addition, a consumer can connect to the content server 70 by directly entering the address of the content server written on a DVD surface.

In Step 2, when the ID information of the DVD 10 is encrypted with a predetermined media key Km, such as E(Km, ID information), the PC 60 retrieves the media key Km by using the information recorded on the DVD 10 and the DVD driver before accessing the content server. Then, the PC 60 produces the ID information by decrypting encrypted ID information D (Km, ID information) using the retrieved media key km. Here, the E and D denote encryption and decryption functions, respectively. These functions are implemented by using, for example, commonly used encryption and decryption algorithms, respectively.

In addition, the PC 60 creates a session key. The PC 60 encrypts the ID information and the session key using a public key of the server corresponding to a Uniform Resource Locator (URL) of the content server 70 as a function E(Pub, ID information∥session key), and transmits the encrypted ID information and session key to the content server 70.

In Step 3, the content server 70 decrypts the encrypted ID information and session key with its own private key and determines whether the ID information is correct. When the ID information is authenticated to be correct, a contents list, together with an authentication success signal, is transmitted to the PC 60.

In Step 4, since the authentication is successful in Step 3, a consumer selects contents on a contents list information screen of the server 70. In Step 5, the server 70 checks the remaining capacity from the marginal capacity information recorded on the lead-in area of the DVD 10 and the data capacity information recorded on the data area of the DVD 10 to determine the remaining disc capacity. When the contents have the capacity less than the remaining capacity, the server 70 uploads the contents to the PC 60. In addition, the server 70 may check the grade information of the DVD 10 for approving the download of contents. In the beginning of communication, such information can be transmitted from the PC 60 to the server 70. In this case, the encryption and decryption processes are performed for communication security.

In Step 6, the PC 60 records the downloaded contents on the data area of the DVD.

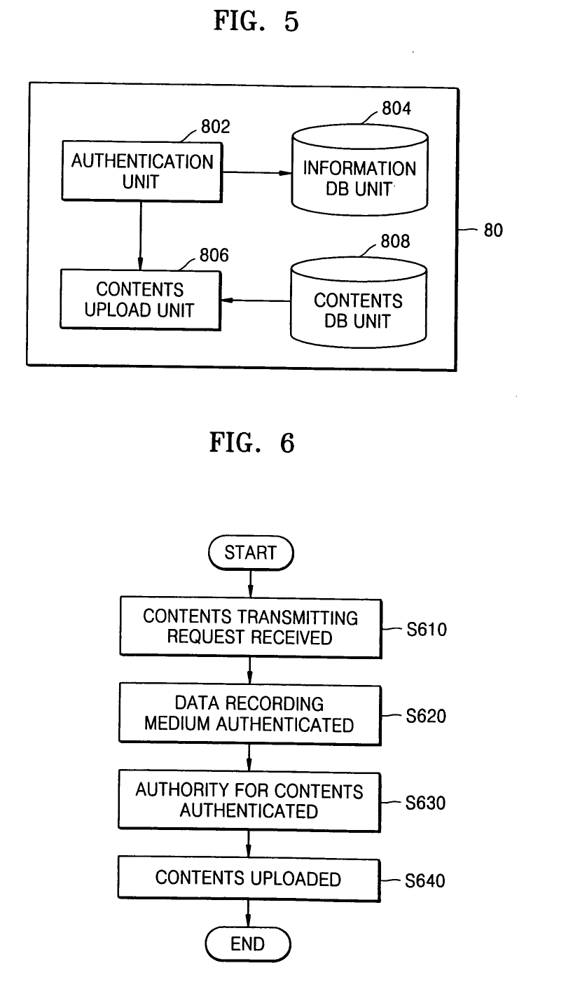

FIG. 5 is a block diagram showing an apparatus for providing contents according to another embodiment of the present invention. The apparatus 80 for providing contents authenticates a prepaid card type data recording medium according to an embodiment of the present invention and uploads the contents to the data recording medium. The apparatus 80 for providing contents comprises an authentication unit 802 for authenticating a data recording medium, an information DB unit 804 for storing personal identification information allocated to the data recording medium, a contents DB unit 808 for storing contents, and a contents upload unit 806 for reading predetermined contents from the contents DB unit 808 and uploading the contents to the data recording medium in case of successful authentication.

The authentication unit 802 authenticates personal identification information recorded on a control information area of a data recording medium which is being played on a computer connected to the apparatus 80 for providing contents by referring to the information DB unit 804. In other words, the information DB unit 804 stores a list of sold prepaid card type data recording media according to the personal identification information. The authentication unit 802 determines whether there is any information in the information DB unit 804 corresponding to the personal identification information recorded on the control information area of the data recording medium which is being played on a computer connected to the apparatus for providing contents 80.

In case of authentication success in the authentication unit 802, the contents upload unit 806 reads from the contents DB unit 808 the contents which a consumer selects through a general purpose computer connected to the apparatus for providing contents 80, and uploads to the general purpose computer.

Meanwhile, when control information such as marginal capacity information and grade information in addition to the personal identification information is further recorded on the control information area of the prepaid card type data recording medium, the authentication unit 802 authenticates the authority for contents which a consumer wants to download as follows. Firstly, the authentication unit 802 computes the currently downloadable data capacity from both the marginal capacity information of the data recording medium and the contents capacity information already recorded in the data area. Next, the authentication unit 802 determines whether the contents to be currently downloaded correspond to the grade information of the data recording medium.

On the other hand, when only the personal identification information is recorded on the control information area of the prepaid card type data recording medium without the marginal capacity information and the grade information, the information DB unit 804 stores the personal identification information according to the marginal capacity information and the grade information. The marginal capacity information and the grade information corresponding to the personal identification information are provided to the authentication unit 802 according to the request of the authentication unit 802. On the basis of the information, the authentication unit 802 authenticates the authority for the contents which the consumer wants to download.

FIG. 6 is a flowchart showing the process that the apparatus 80 of FIG. 5 performs including receiving the contents transmitting request, authenticating the data recording medium, and uploading the contents.

In step S610, the apparatus 80 receives contents transmitting request information from a computer playing back a prepaid card type data recording medium. The authentication unit 802 also receives control information recorded on a control information area of the data recording medium. In step S620, the apparatus 80 authenticates the data recording medium by comparing ID information recorded on the control information area of the data recording medium with ID information stored in the information DB unit 804. In step S630, when the authentication for the data recording medium is successful in step S620, the apparatus 80 determines whether there is the authority for the requested contents by referring to the marginal capacity information and the grade information which are stored in the control information area of the data recording medium or recorded on the information DB unit 804. In case of authentication success in step S630, the contents upload unit 806 reads the contents from the contents DB unit 808 and uploads the contents in step S640.

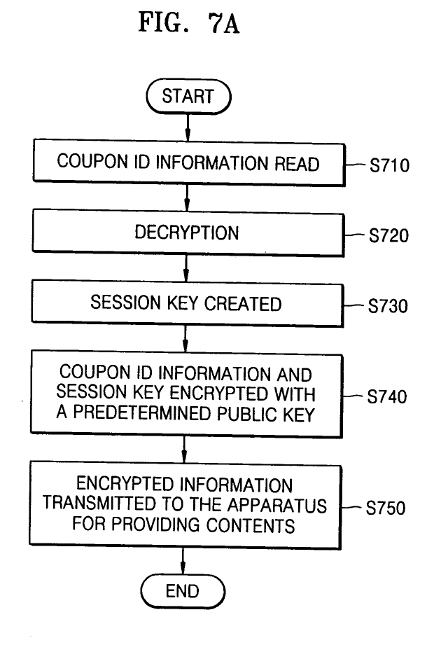

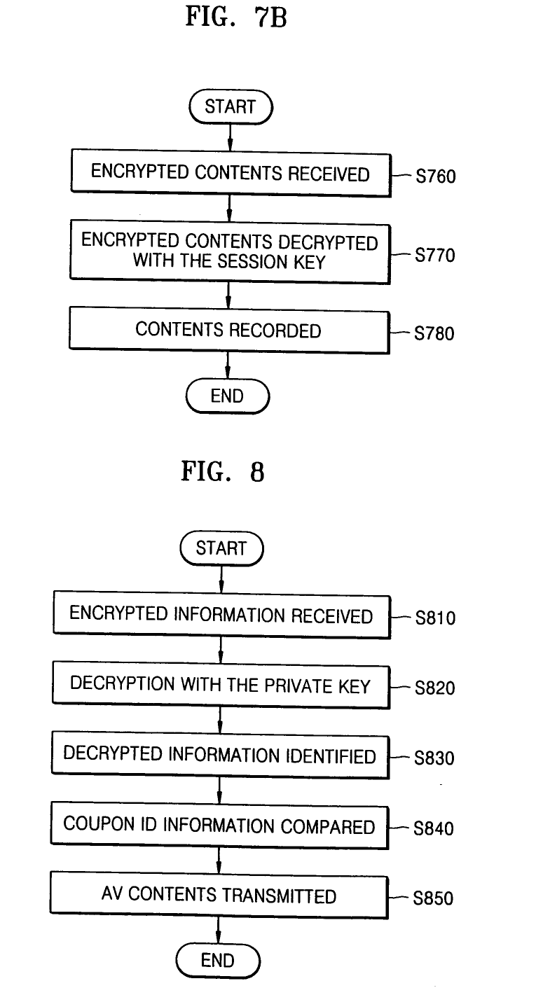

FIGS. 7A, 7B, and 8 are flowcharts showing a method of authenticating a data recording medium between a data recording medium, a disc driving apparatus for driving the data recording medium, and an apparatus for providing AV contents to the data recording medium, and providing AV contents to the authenticated data recording medium, according to an embodiment of the present invention.

FIG. 7A is a flowchart showing a process in which a disc driving apparatus encrypts coupon ID information of a data recording medium and transmits the encrypted coupon ID information to an apparatus for providing AV contents. FIG. 7B is a flowchart showing a process in which the disc driving apparatus receives encrypted AV contents from the apparatus for providing AV contents and records decrypted AV contents on the data recording medium.

In step S710, the disc driving apparatus reads coupon ID information encrypted with a predetermined media key Km. In step S720, the disc driving apparatus decrypts the coupon ID information encrypted in step S710 by using a media key provided in the disc driving apparatus for illegal copy protection. If the disc driving apparatus is an illegally copied apparatus, the disc driving apparatus cannot decrypt the coupon ID information with its own media key.

In step S730, a session key (e.g., random numbers) is created as the final step for the encryption of the coupon ID information. In step S740, the coupon ID information decrypted in step S720 and the session key created in step S730 are encrypted with a predetermined public key. For the encryption and decryption above, conventional encryption and decryption algorithms can be used. In step S750, the information encrypted in step S740 is transmitted to the apparatus for providing AV contents. The apparatus for providing AV contents which receives the encrypted information authenticates the coupon ID information according to the flowchart shown in FIG. 8. When the authentication is successful, the AV contents are transmitted to the disc driving apparatus.

In step 760 of FIG. 7B, the disc driving apparatus receives the AV contents encrypted and transmitted in the apparatus for providing AV contents after the authentication success for the data recording medium. In step S770, the encrypted AV contents are decrypted again with the session key created in step S730. In step S780, the decrypted AV contents are recorded on the data recording medium.

FIG. 8 is a flowchart showing a process in which the apparatus for providing AV contents receives the information encrypted in accordance with the flowchart of FIG. 7A from the disc driving apparatus and authenticates the data recording medium, and, when the authentication is successful, the apparatus for providing AV contents encrypts the AV contents and transmits the encrypted AV contents to the disc driving apparatus.

In step S810, the apparatus for providing AV contents receives the information encrypted in step S740. In step S820, the apparatus for providing AV contents decrypts the encrypted information with its own private key. In step S830, the apparatus for providing AV contents identifies the decrypted information separately as the coupon ID information of the data recording medium and the session key created in the disc driving apparatus. In step S840, the apparatus for providing AV contents compares the separately identified coupon ID information with the coupon ID information stored in database of the apparatus for providing AV contents. In step S850, if the separately identified coupon ID information is equal to the coupon ID information stored in the apparatus for providing AV contents as the result of the comparison, the apparatus for providing AV contents encrypts predetermined AV contents by using the session key separately identified in step S830 and transmits the encrypted AV contents to the disc driving apparatus.

According to an example of the present invention, it is possible to provide a data recording medium capable of securing personal anonymity in downloading contents by using a DVD in a manner that is similar to a prepaid card and at the same time overcoming the high-cost problem of the prepaid card.

In addition, it is possible to create a new profitable business model by using an apparatus for providing various contents to a prepaid card type data recording medium.

While the present invention has been described with reference to exemplary embodiments thereof, it will be understood by those skilled in the art that various changes in form and details may be made therein without departing from the scope of the present invention as defined by the following claims.

1. A prepaid card type data recording medium comprising:
a data area on which contents are to be recorded; and
a control information area on which is recorded coupon ID information for identifying the data recording medium and for representing an authority for recording contents on the data area.

2. The prepaid card type data recording medium according to claim 1, wherein the coupon ID information is encrypted with a predetermined media key.

3. The prepaid card type data recording medium according to claim 1, wherein marginal capacity information for indicating a maximum downloadable capacity of contents is further recorded on the control information area.

4. The prepaid card type data recording medium according to claim 1, wherein grade information for indicating a grade of the data recording medium is further recorded on the control information area.

5. The prepaid card type data recording medium according to claim 1, wherein downloadable address information of a communication network is further recorded on the control information area.

6. A data recording apparatus for recording data on a data recording medium comprising:
an area creating unit which creates a data area on which contents are to be recorded and a control information area on which control information is recorded; and
a control information recording unit which records coupon ID information in the control information area for identifying the data recording medium and representing the authority for recording contents on the data area.

7. The data recording apparatus for recording data on a data recording medium according to claim 6, wherein the control information recording unit encrypts the coupon ID information with a predetermined media key.

8. The data recording apparatus for recording data on a data recording medium according to claim 6, wherein the control information recording unit further records, on the control information area, marginal capacity information for indicating a maximum downloadable capacity of contents.

9. The data recording apparatus for recording data on a data recording medium according to claim 6, wherein the control information recording unit further records on the control information area grade information for indicating a grade of the data recording medium.

10. The data recording apparatus for recording data on a data recording medium according to claim 6, wherein the control information recording unit further records on the control information area downloadable address information of a communication network.

11. An apparatus for providing contents to a data recording medium including a data area on which contents are to be recorded and a control information area on which is recorded control information including coupon ID information for identifying the data recording medium and representing an authority for recording contents, the apparatus comprising:
an authentication unit for authenticating the coupon ID information; and
a contents upload unit for uploading predetermined contents to the data recording medium when the authentication unit authenticates the coupon ID information.

12. The apparatus for providing contents according to claim 11 further comprising an information DB unit which stores marginal capacity information indicating the marginal capacity of contents to be downloaded to the data recording medium according to the coupon ID information, and wherein the authentication unit determines whether to upload the predetermined contents by referring to the information DB.

13. The apparatus for providing contents according to claim 12, wherein the information DB unit further stores grade information indicating a grade of the data recording medium according to the coupon ID information, the authentication unit further authenticating the grade information to determine whether to upload the predetermined contents.

14. The apparatus for providing contents according to claim 11, wherein the marginal capacity information indicating the marginal capacity of contents to be downloaded to the data recording medium is further recorded on the control information area, and the authentication unit determining whether to upload the predetermined contents by referring to the marginal capacity information.

15. The apparatus for providing contents according to claim 12, wherein the grade information indicating the grade of the data recording medium is further recorded on the control information area, the authentication unit further authenticating the grade information to determine whether to upload the predetermined contents.

16. An authentication method performed in a disc driving apparatus between a data recording medium and the disc driving apparatus and between the disc driving apparatus and an apparatus for providing AV contents, the data recording medium including a data area on which AV contents are to be recorded and a control information area on which coupon ID information for identifying the data recording medium and representing an authority of AV contents is recorded, the disc driving apparatus for driving the data recording medium, and the apparatus for providing the AV contents to the data recording medium, the method comprising:
(a) reading the coupon ID information encrypted with a predetermined media key from the data recording medium;
(b) decrypting the coupon ID information by using a media key of the disc driving apparatus;
(c) creating a predetermined session key;
(d) encrypting the decrypted coupon ID information and the session key by using a predetermined public key; and
(e) transmitting the encrypted coupon ID information and session key to the apparatus for providing AV contents.

17. The authentication method performed in the disc driving apparatus according to claim 16 further comprising:
(f) receiving AV contents encrypted with the session key from the apparatus for providing AV contents; and
(g) decrypting the encrypted AV contents with the session key.

18. An authentication method performed in an apparatus for providing AV contents between a data recording medium and a disc driving apparatus and between the disc driving apparatus and the apparatus for providing AV contents, the data recording medium including a data area on which AV contents are recorded and a control information area on which coupon ID information for identifying the data recording medium and representing the authority of AV contents is recorded, the disc driving apparatus for driving the data recording medium, and the apparatus for providing the AV contents to the data recording medium, the method comprising:
(a) encrypting with a predetermined public key from the disc driving apparatus the coupon ID information and a session key;
(b) decrypting the information encrypted by the public key with a private key of the apparatus for providing AV contents;
(c) identifying the decrypted information as the coupon ID information and the session key;
(d) comparing the coupon ID information with a predetermined coupon ID information stored in the apparatus for providing AV contents; and
(e) encrypting predetermined AV contents by using the session key and transmitting the encrypted AV contents to the disc driving apparatus in accordance with the comparison result.

19. The authentication method performed in the apparatus for providing AV contents according to claim 18, wherein the encrypted AV contents is transmitted to the disc driving apparatus only when the coupon ID information is equal to the predetermined coupon ID information stored in the apparatus for providing AV contents.
